(19) United States
(12) Patent Application Publication
(10) Pub. No.: US 2012/0116997 A1
(43) Pub. Date: May 10, 2012

(54) OTC Options on Actively Managed Portfolios in Grantor Retained Annuity Trusts (GRATs)

(76) Inventors: Michael Garrett, Jersey City, NJ (US); Matthew Fleming, New York, NY (US); Michael Davis, New York, NY (US); Warun Kumar, New York, NY (US)

(21) Appl. No.: 13/291,341

(22) Filed: Nov. 8, 2011

Related U.S. Application Data
(60) Provisional application No. 61/411,221, filed on Nov. 8, 2010.

(51) Int. Cl. G06Q 40/06

(52) U.S. Cl. 705/36 R

(57) ABSTRACT

A method and apparatus for controlling the volatility experienced by a grantor using a grantor retained annuity trust (GRAT) or the like provides a fund that may sell call spreads to the GRAT and shares in the fund to the grantor. Countervailing value movements in the fund and the value of the call spreads may be adjusted to control volatility and provide more certainty in the calculation of the grant annuity stream.

### CROSS-REFERENCE TO RELATED APPLICATIONS

This application claims the benefit of U.S. provisional application 61/411,221 filed Nov. 8, 2010 and hereby incorporated in its entirety by reference.

### BACKGROUND OF THE INVENTION

The present invention relates generally to a method of reducing investor risk when using investment vehicles such as Grantor Retained Annuity Trusts.

Grantor Retained Annuity Trusts (GRAT) allow a grantor to retain rights to receive an annuity based on the investment in the GRAT. At the end of the GRAT's term, the assets of the GRAT are distributed to one or more family member beneficiaries or a trust for family member's benefit.

The amount of money passed to family members from the GRAT increases if the assets held by the GRAT generate a high rate of return. For this reason, grantors are often advised to invest the GRAT assets in high return assets. Unfortunately, such high return assets often are accompanied by high volatility exposing the grantor to undesired risk. The high volatility of such assets can make it difficult for many investors to own such assets due to their high risk nature.

### SUMMARY OF THE INVENTION

The present invention provides a fund that can be used as the basis for the assets contained in a GRAT. The fund sells call spreads to the GRAT and issues shares to the grantor in exchange for an investment in the fund. The call spreads increase the effective return of the fund assets (in the manner of call option leveraging) satisfying the grantor's desire to increase money passed to family members. The increased volatility that accompanies these high returns, is moderated by the grantor's separate investment in the fund itself, which changes in value counter to the changes in value of the call spreads held by the GRAT. The use of call spreads allows the fund to be fully collateralized against its potential obligations under the call spreads.

Specifically then the present invention provides a method and system to perform the steps of:

a. receive a desired investment amount and call spread strike and call values;

b. determine a maximum number of call spreads from the investment amount and call spread strike and call values;

c. divide the desired investment amount between a fund purchase amount and a call spread amount based on the results of (b); and

d. sell to an individual an ownership in a fund of investments according to the fund purchase amount and to a trust owned by the individual according to the call spread amount.

It is thus a feature of at least one embodiment of the invention to provide a method of reducing the volatility experienced by a grantor associated with high return investments desired for use in a GRAT or similar trust.

These particular objects and advantages may apply to only some embodiments falling within the claims and thus do not define the scope of the invention.

### BRIEF DESCRIPTION OF THE DRAWINGS

FIG. 1 is a diagram of the principal hardware components implementing the present invention;

FIG. 2 is a block diagram showing the flow of assets implemented by the present invention;

FIG. 3 is set of tables illustrating one example of the present invention; and

FIG. 4 is a table for illustrating an example for the present invention of end values for the cash invested in both the Fund and the Call Spreads at expiration for several return scenarios.

### DETAILED DESCRIPTION OF THE PREFERRED EMBODIMENT

### Overview

The invention generally provides an investment partnership (a “Fund”), which will invest in an actively managed portfolio, a combination of actively managed portfolios, an actively managed portfolio using passively managed implementation vehicles (exchange traded funds or index funds), or any combination of these strategies (collectively the “Underlying Strategy”). An actively managed portfolio is a portfolio of securities such as stocks, bonds, currencies, commodities, or combinations thereof that are professionally managed in a way to increase returns and/or reduce risk versus an investment in an index or passive basket of securities. These actively managed portfolios may be in the form of a separate account, a mutual fund, a hedge fund, or other vehicle. Investors contribute money or securities to a Fund (the “Fund”) which is managed according to the Underlying Strategy by a sub-advisor(s) in a managed account or through a pooled vehicle (such as a mutual fund, ETF, ETN, Limited Partnership, etc.).

The Fund sells OTC call spread contracts (the “Call Spreads”) linked to the performance of the aggregate pool of the Fund assets. It is important to distinguish that the payoff of the Call Spreads references the performance of the entire Fund; they are not structured as a series of options on the individual holdings within the Underlying Strategy.

A call option gives the purchaser the right, but not the obligation, to buy an asset at a predetermined price (the “strike price”) on a predetermined date. A call spread is the combination of a purchase of a call option with a lower strike price and the sale of a call option with a higher strike price. Each call option makes reference to the same underlying security or portfolio of securities, and allows the purchaser of the call spread to participate in any gains in the underlying security or portfolio of securities from the lower strike price up to and including the higher strike price. When exercised, the options can be settled by transferring the assets underlying the option or by settling in cash (by the purchaser receiving cash equal to the value of the option upon exercise or maturity). The options can also be sold to another party who may exercise the option providing a similar economic effect to exercise at that date. The options used in this invention will usually be settled by transferring the assets underlying the option.

The cost of a Call Spread can be evaluated by subtracting the value of the call option with the higher strike from the value of the call option with the lower strike.

Cₛ=C_{L}−C_{U}

Where,

Cₛ is the value of the Call Spread

C_{L} is the value of the Call Option with the lower strike (the “Strike Price”)

C_{U} is the value of the Call Option with the higher strike (the “Cap”)

The value of a call option and thus the value of the Call Spread can be determined using generally accepted valuation methodologies, such as the following formula:

Cₜ=S_{y}N(d₁)−Xe^{-rτ}N(d₂)

Where,

Cₜ is the value of a call option

N(•) is the cumulative density function of normal distribution

$$N ( {d}_{1} ) = {\int }_{- ∞}^{{d}_{1}} f ( u ) d u = {\int }_{- ∞}^{{d}_{1}} \frac{1}{2 π} {e}^{- \frac{{u}^{2}}{2}} d u$$

$${d}_{1} = \frac{ln ( \frac{{S}_{t}}{X} ) + ( r + \frac{{σ}^{2}}{2} ) τ}{σ \sqrt{τ}}$$

$${d}_{2} = \frac{ln ( \frac{{S}_{t}}{X} ) + ( r - \frac{{σ}^{2}}{2} ) τ}{σ \sqrt{τ}} = {d}_{1} - σ \sqrt{τ}$$

τ=T−t

S is the value of the actively managed portfolio

X is the strike price of the call option

r is the risk free interest rate

T−t is the time to maturity

σ is the volatility of returns of the actively managed portfolio

The invention can be used in conjunction with estate planning vehicles (such as grantor retained annuity trusts) to enhance the wealth transfer efficacy of the vehicle, through a multitude of option positions at various strike prices and could include any combination of long and short positions in call options and/or put options on an underlying strategy, including, but not limited to, various option spread strategies, butterflies, straddles, strangles, collars, etc.

### Example I

This example describes one embodiment of this invention that utilizes a Fund investment, combined with a grantor retained annuity trust (GRAT) purchasing the call spreads written by the Fund.

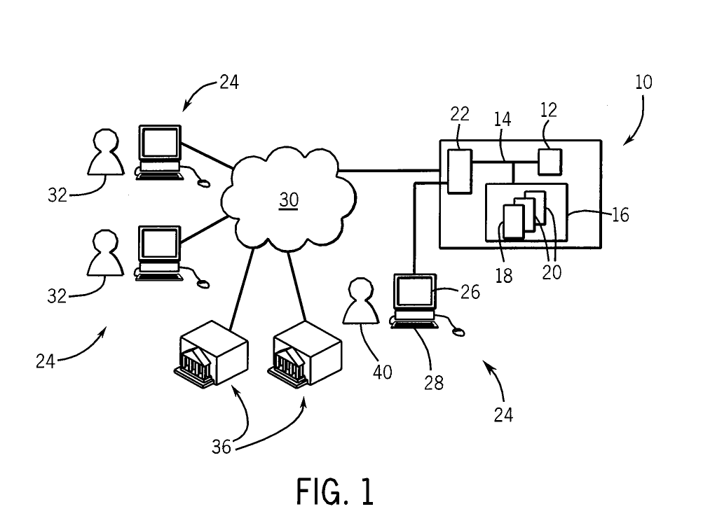

Referring to FIG. 1, the present invention may be implemented on an electronic computer 10 having a processor 12 communicating via an internal bus 14 with a memory system 16, for example, being a random access memory and magnetic disk system.

The memory 16 may hold a program 18 to be described in more detail below together with various data files 20 that will be used by the program 18.

The bus 14 may communicate with an interface 22 that may provide for electrical connection to a user terminal 24. The terminal, as understood in the art, may include a monitor 26 for displaying alphanumerics and graphics and a user input device 28 such as a keyboard or mouse or the like.

The interface 22 may further communicate with a network 30 such as the Internet allowing the ability to exchange electronic signals with other individuals including grantors 32 via corresponding terminals 24, and with various financial institutions 36 such as may buy and trade assets suitable for use in the fund of the present invention and which may execute contracts implemented by electronic instructions from the computer 10 for call options and the like.

Generally, the program 18 will provide for necessary configurations of the desired instruments to be described below and may implement sales and purchases through the network 30 of those instruments.

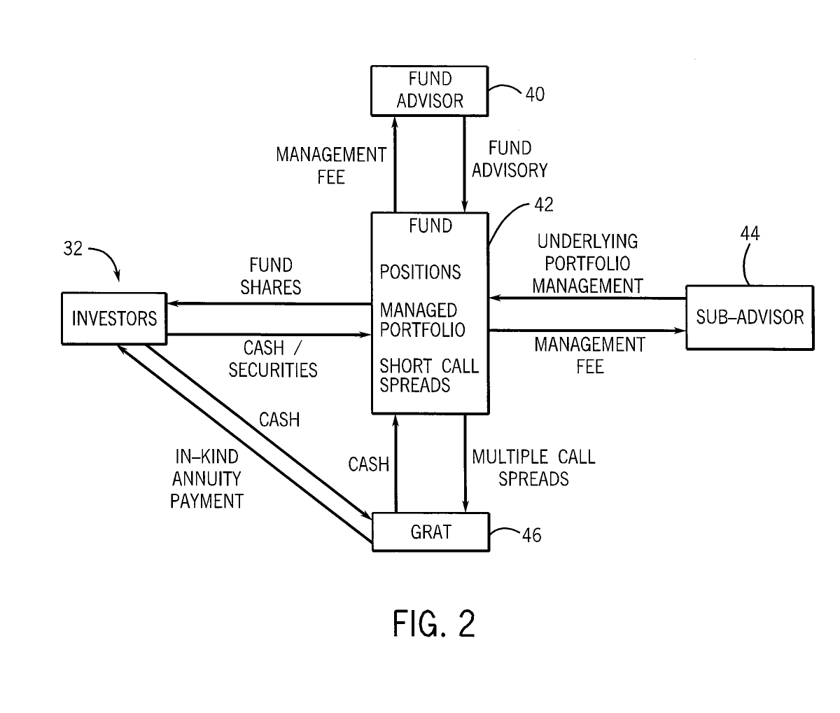

Referring to FIG. 2, a fund advisor 40 may use the above described computer 10 to create a new fund (the “Fund”) 42 which invests in an actively managed portfolio managed by an external sub-advisor 44 (also communicating with the computer 10 but not shown in FIG. 1 for clarity). Investors such as grantors 32 contribute securities (or cash to purchase securities) to the Fund 42. Any individual investor may be limited to a 49% ownership stake in the Fund. The Fund 42 receives upfront premium for issuing Call Spreads to investors seeking the positive performance of the Actively Managed Portfolio.

### Quantity of Call Spreads Issued by Enhanced Fund

The computer program 18 (shown in FIG. 1) may receive input from a user 40 providing the size of the Fund, the Actively Managed Portfolio, and the targeted maximum return expected in the Actively Managed Portfolio. The quantity of Call Spreads which can be sold by the Fund 42 to a GRAT 46 is then calculated, using two primary factors:

a. The Maximum Payout of each Call Spread

b. The Cap

The payoff of the Call Spreads, if any, will be funded by the Fund 42. The Cap is the minimum Net Asset Value (NAV) level of the Fund at which the Call Spreads will have their maximum value at expiration. The Fund 42 will have its greatest Call Spread obligation and lowest asset value when the underlying portfolio has an ending value equal to the Cap. Accordingly, the maximum number of Call Spreads the Fund 42 can issue is equal to the Cap divided by the maximum Call Spread payoff or:

S_{U}/(S_{U}−S_{L})

where:

S_{U} The Cap (the upper strike where a Call is sold)

S_{L} The Strike Price (the lower strike where a Call is bought)

Example:

Fund Initial Net Asset Value=$100

Strike Price=$100

Cap=$115

Maximum Payoff=$15

S_{U}/(S_{U}−S_{L})

or

$115/($115−$100)=7.67 Call Spreads

This value is then output from the computer program.

Referring still to FIG. 2, the Call Spreads may be purchased by a grantor retained annuity trust (“GRAT”) 46 which is a specific type of estate planning vehicle. GRATs, as part of their construction, are required to make annual payments out of the trust, and the rate used to determine the size of these payments is often referred to as the “7520 Rate.”

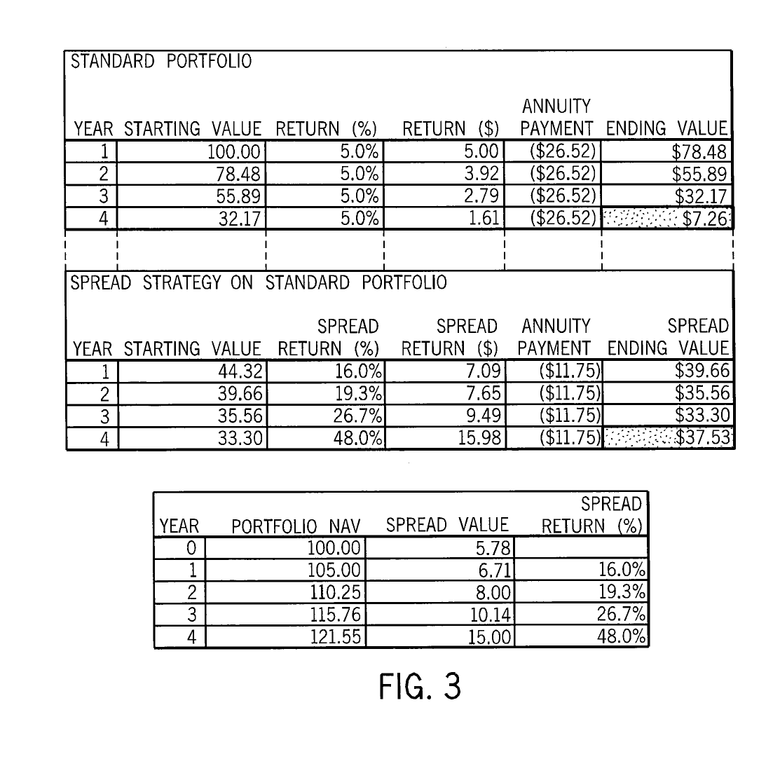

Referring now to FIG. 3, example calculations comparing a standard portfolio to the portfolio of the present invention are provided. The Call Spreads are linked to an Actively Managed Portfolio which is assumed to grow at 5% per year, and the maturity of the Call Spreads and GRAT is assumed to be 4 years.

Strike Price: 100

Cap: 115

Cost of Spread: 5.61

Maximum Spread Payoff: 15.00

Number of Call Spreads: 7.67

7520 Rate: 1.4%

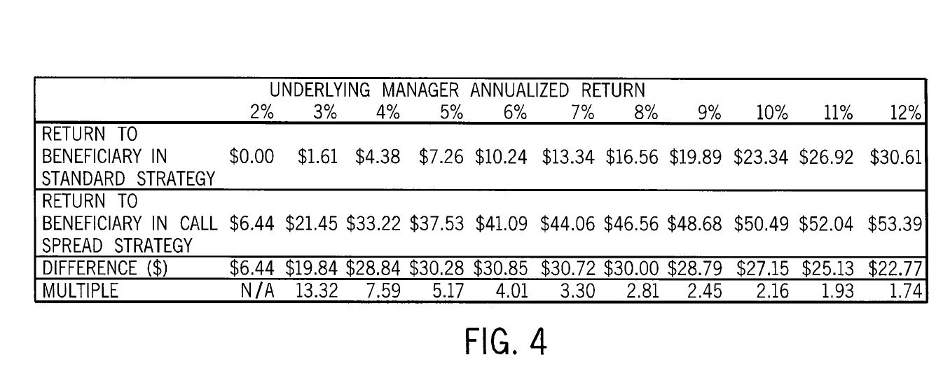

Referring now to FIG. 4, cash invested in both the Fund and the Call Spreads at the end of the 4 year expiration for several return scenarios for the Actively Managed Portfolio are provided given the following assumptions:

$100 Actively Managed Portfolio NAV

$100 Strike Price

$115 Cap

4-year term

$5.61 Call Spread cost

7.67 Call Spreads purchased

The amount that a Grantor can put into the GRAT and the Fund per $100 total commitment to the strategy can be calculated by the program as follows:

Call Spreads in GRAT:

Call Spread cost×Call Spreads purchased=GRAT cash outlay

$5.61×7.67=$43.01 Call Spread purchase in GRAT

Fund Investor:

$100−GRAT Cash outlay=Fund cash outlay

$100−$43.01=$56.99 Fund cash outlay

Fund: From capital commitments to the fund and through premium received from the sale of Call Spreads, there is a $100 investment in Actively Managed Portfolio managed by a sub-advisor.

If an investor in the Fund donates money into a GRAT which invests in the Call Spreads issued by the Fund, the market risk is equivalent to gifting the entire amount into a GRAT in the same strategy.

It will be understood that the steps described above as implemented in electronic computer may include not only the calculations detailed in the above description, but also the implementation of necessary purchase contracts and sales contracts for example by preparing the necessary papers or by implementing the sales and purchases through an electronic network such as the web or the like. Thus the present invention may perform not only the calculations but may make the necessary sales and purchases through electronically implemented or augmented markets or pre-existing contracts and data obtained over the web or the like.

It is important to note that the present invention is directed toward decreasing the exposure of the grantor to volatility. The returns to the beneficiary are primarily determined by the yield of the investment and yields identical to that obtained by the present invention are possible without the present invention, for example, by purchase of call spreads on an identical asset pool without other investment in the underlying assets. For similar reasons, the present invention does not fundamentally change the tax obligations of the grantor with respect to similar investments without use of the invention. Thus, while the present invention relates to instruments having tax consequences, it is not primarily directed toward reducing tax liabilities.

Due to the structure, the present invention can also simplify the process of setting the annuity amount. For this reason, the present invention may be employed even without the desire for higher investment returns.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a computer” and “a processor” can be understood to include one or more controllers or processors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications are hereby incorporated herein by reference in their entireties.

1. A program stored in a non-transient media and executable on an electronic computer to perform the steps of:
(a) receive a desired investment amount and call spread strike and call values;
(b) determine a maximum number of call spreads from the investment amount and call spread strike and call values;
(c) divide the desired investment amount between a fund purchase amount and a call spread amount based on the results of (b); and
(d) sell to an individual and ownership in a fund of investments according to the fund purchase amount and to a trust owned by the individual according to the call spread amount.

2. The program executable on an electronic computer of claim 1 wherein the maximum number of call spreads is according to the formula:
maximum number of call spreads=S_{U}/(S_{U}−S_{L})
where:
S_{U} is the upper strike where call share is sold
S_{L} is the lower strike where the call share is purchased

3. The program executable on an electronic computer of claim 1 wherein the trust is a grantor retained annuity trust.

4. The program executable on an electronic computer of claim 1 further including the step of determining a sale price of the call spread amount according to the following formula:
sale price of the call spread>=C_{L}−C_{U}
where:
C_{L} is the value of the call option with the lower strike of the call spread;
C_{U} is the value of the call option with the higher strike of the call spread; and
wherein the value of the underlying call options for the lower strike and higher strike are computed according to the following formula:
Cₜ=SₜN(d₁)−Xe^{-rτ}N(d₂)
where:
Cₜ is the value of a call option
N(•) is the cumulative density function of a normal distribution
$$N ( {d}_{1} ) = {\int }_{- ∞}^{{d}_{1}} f ( u ) d u = {\int }_{- ∞}^{{d}_{1}} \frac{1}{2 π} {e}^{- \frac{{u}^{2}}{2}} d u$$
$${d}_{1} = \frac{ln ( \frac{{S}_{t}}{X} ) + ( r + \frac{{σ}^{2}}{2} ) τ}{σ \sqrt{τ}}$$
$${d}_{2} = \frac{ln ( \frac{{S}_{t}}{X} ) + ( r - \frac{{σ}^{2}}{2} ) τ}{σ \sqrt{τ}} = {d}_{1} - σ \sqrt{τ}$$
where:
τ=T−t
S is the value of the actively managed portfolio
X is the strike price of the call option
r is the risk free interest rate
T−t is the time to maturity
σ is the volatility of returns of the actively managed portfolio

5. A method of managing volatility in trust assets comprising the steps of:
(a) receiving a desired investment amount and call spread strike and call values;
(b) determining a maximum number of call spreads from the investment amount and call spread strike and call values;
(c) dividing the desired investment amount between a fund purchase amount and a call spread amount based on the results of (b); and
(d) selling to an individual and ownership in a fund of investments according to the fund purchase amount and to a trust owned by the individual according to the call spread amount.

6. The method of claim 5 wherein the maximum number of call spreads is according to the formula:
maximum number of call spreads=S_{U}/(S_{U}−S_{L})
Where:
S_{U} is the upper strike where call share is sold
S_{L} is the lower strike where the call share is purchased

7. The method of claim 5 wherein the trust is a grantor retained annuity trust.

8. The method of claim 5 further including the step of determining a sale price of the call spread amount according to the following formula:
sale price of the call spread>=C_{L}−C_{U}
where:
C_{L} is the value of the call option with the lower strike of the call spread;
C_{U} is the value of the call option with the higher strike of the call spread;
and wherein the value of the underlying call options for the lower strike and higher strike are computed according to the following formula:
Cₜ=SₜN(d₁)−Xe^{-rτ}N(d₂)
where:
Cₜ is the value of a call option
N(•) is the cumulative density function of a normal distribution
$$N ( {d}_{1} ) = {\int }_{- ∞}^{{d}_{1}} f ( u ) d u = {\int }_{- ∞}^{{d}_{1}} \frac{1}{2 π} {e}^{- \frac{{u}^{2}}{2}} d u$$
$${d}_{1} = \frac{ln ( \frac{{S}_{t}}{X} ) + ( r + \frac{{σ}^{2}}{2} ) τ}{σ \sqrt{τ}}$$
$${d}_{2} = \frac{ln ( \frac{{S}_{t}}{X} ) + ( r - \frac{{σ}^{2}}{2} ) τ}{σ \sqrt{τ}} = {d}_{1} - σ \sqrt{τ}$$
where:
τ=T−t
S is the value of the actively managed portfolio
X is the strike price of the call option
r is the risk free interest rate
T−t is the time to maturity
σ is the volatility of returns of the actively managed portfolio

9. An electronic system of managing financial assets comprising at least two electronic computers executing stored programs to implement the steps of:
(a) receiving a desired investment amount and call spread strike and call values;
(b) determining a maximum number of call spreads from the investment amount and call spread strike and call values;
(c) dividing the desired investment amount between a fund purchase amount and a call spread amount based on the results of (b); and
(d) selling to an individual and ownership in a fund of investments according to the fund purchase amount and to a trust owned by the individual according to the call spread amount.

10. The electronic system of claim 9 wherein the maximum number of call spreads is according to the formula:
maximum number of call spreads=S_{U}/(S_{U}−S_{L})
Where:
S_{U} is the upper strike where call share is sold
S_{L} is the lower strike where the call share is purchased

11. The electronic system of claim 9 wherein the trust is a grantor retained annuity trust.

12. The electronic system of claim 9 further including the step of determining a sale price of the call spread amount according to the following formula:
sale price of the call spread>=C_{L}−C_{U}
where:
C_{L} is the value of the call option with the lower strike of the call spread;
C_{U} is the value of the call option with the higher strike of the call spread;
and wherein the value of the underlying call options for the lower strike and higher strike are computed according to the following formula:
Cₜ=SₜN(d₁)−Xe^{-rτ}N(d₂)
where:
Cₜ is the value of a call option
N(•) is the cumulative density function of a normal distribution
$$N ( {d}_{1} ) = {\int }_{- ∞}^{{d}_{1}} f ( u ) d u = {\int }_{- ∞}^{{d}_{1}} \frac{1}{2 π} {e}^{- \frac{{u}^{2}}{2}} d u$$
$${d}_{1} = \frac{ln ( \frac{{S}_{t}}{X} ) + ( r + \frac{{σ}^{2}}{2} ) τ}{σ \sqrt{τ}}$$
$${d}_{2} = \frac{ln ( \frac{{S}_{t}}{X} ) + ( r - \frac{{σ}^{2}}{2} ) τ}{σ \sqrt{τ}} = {d}_{1} - σ \sqrt{τ}$$
where:
τ=T−t
S is the value of the actively managed portfolio;
X is the strike price of the call option
r is the risk free interest rate
T−t is the time to maturity
σ is the volatility of returns of the actively managed portfolio.
